(19) United States
(12) Patent Application Publication
(10) Pub. No.: US 2010/0038873 A1
(43) Pub. Date: Feb. 18, 2010

(54) Steering knuckle with spindle and method of making same

(76) Inventor: Stoyan Stoychey, Kalamazoo, MI (US)

Correspondence Address: MARSHALL & MELHORN, LLC, FOUR SEAGATE, 8TH FLOOR, TOLEDO, OH, 43804, US

(21) Appl. No.: 12/583,040

(22) Filed: Aug. 13, 2009

Related U.S. Application Data
(60) Provisional application No. 61/188,953, filed on Aug. 14, 2008.

(51) Int. Cl. B62D 7/18; B22D 11/126

(52) U.S. Cl. 280/93.512; 29/527.6

(57) ABSTRACT

A forged or cast vehicle steering knuckle with spindle and a method of making the same are disclosed. The knuckle has an upper boss portion, a lower boss portion, and a spindle portion. The spindle portion has a tapered conical channel. The knuckle is formed, by way of forging or casting, in the axial direction, to orient the grains of the material also in the axial direction.

### FIELD OF THE INVENTION

The present invention relates to a steering knuckle with a spindle for a vehicle and a method of making the same. More particularly, the present invention relates to a forged or cast spindle for a knuckle with a tapered conical channel and a method of making the same.

### BACKGROUND OF THE INVENTION

Wheel knuckles are well-known structures that are typically pivotally attached to the two ends of an axle of a vehicle. Each wheel knuckle typically comprises a spindle. The spindle rotationally supports a wheel, and its associated tire or tires, via one or more bearings located between the knuckle and the wheel.

Early on, wheel spindles were solid throughout and suffered from several disadvantages including the use of added material and its associated weight. Additionally, these designs employed wall thicknesses and transitions between parts of the knuckles that were not uniform or smooth. The non-uniformity of the walls resulted in cooling that was not uniform, which undesirably resulted in distortions in the spindle during manufacturing. Consequently, utilizing knuckle transitions that are not smooth reduces the fatigue life of the knuckle, which results in premature failure.

Later, it was found that tubular spindles provided various advantages over solid spindles, where the tubular spindles were made from tubular blanks or elongated metal tubes that could then be cold formed into a final desired shape, see for example, U.S. Pat. Nos. 3,701,564, 4,002,286, 4,208,900, and 4,417,462. In addition, some tubular spindles were formed by machining a channel therethrough, as disclosed in U.S. Pat. No. 6,623,019. These spindles, however, tend to be costly.

Although some steering knuckles have been produced via forging or casting, to date, a forged or cast knuckle with an integrally formed and unitarily forged or cast tubular spindle has not been successfully produced. This is due, in part, to the inability of releasing a die core from the center of the spindle at the completion of the forging or casting process. However, if such a forged or cast knuckle with a tubular spindle could be produced, it might accurately maintain longitudinal channel alignment throughout a relatively small cross-section over the length of the spindle.

It is also known that a forged or cast part, in general, can benefit from the advantage of orienting material grain elongation along a forged or cast axis, which makes that portion of the part stronger than a corresponding non-forged or non-cast part, especially in an axial direction. Further, if a forged or cast spindle could be made and a portion of the spindle were to have a large enough cross-section, with respect to the portion's length, then the forged or cast spindle's dimension might then hold a tighter tolerance and thus, such a forged or cast portion might be easier to machine and the thickness of such a forging or casting might then be more uniform. As a result of this potential dimensional uniformity, there might then be a more uniform transfer of heat (or conversely, better cooling of the forged or cast portion could be provided), which could help to prevent dimensional distortions.

Hence, if such a tubular forged or cast spindle could be produced, in addition to resulting in less weight, then such a spindle might use less expensive materials, while resulting in better fatigue resistance. Such a forged or cast spindle would also benefit from a more uniform thickness, better dimensional stability during heat treatment, and possibly have a smaller risk of quench cracking. In addition to being more efficient (i.e., lighter) than a solid circular cross-sectional spindle, such a tubular forged or cast spindle could result in resisting bending and torsion better.

It would, therefore, be advantageous for a wheel spindle to be lighter in weight and be designed to minimize the use of material, so as to minimize fatigue as well as to prevent distortions.

### SUMMARY OF THE INVENTION

A forged or cast vehicle steering knuckle comprises an upper boss portion, a lower boss portion and a spindle portion. The spindle portion is integrally formed and unitary with both the upper and the lower boss portions. An opening in the spindle portion is provided between the boss portions. The opening is connected to a forged or cast tapered conical inner channel that extends partially through the spindle portion along a longitudinal axis of the spindle portion.

A method of making a forged or cast vehicle steering knuckle comprises providing a metal billet, heating the metal billet to a predetermined temperature, shaping the heated metal billet in a die to have an upper boss, a lower boss and a spindle portion positioned between and unitary with the bosses, and shaping at least one tapered conical channel that is partially extending within the spindle portion with a corresponding tapered conical protrusion on part of the die. In the case of a cast vehicle steering knuckle, the metal billet is melted and poured into an appropriately shaped die cavity.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a three dimensional view of a vehicle steering knuckle with a spindle in accordance with the present invention;

FIG. 2 is a cross-sectional cut through view of the vehicle steering knuckle with spindle taken along line 2-2 of FIG. 1;

FIG. 3 is a side plan cut through view of the vehicle steering knuckle with spindle of FIG. 1 taken along line 2-2 of FIG. 1;

FIG. 4 is a three dimensional view of forging or casting dies with the vehicle steering knuckle with spindle of FIG. 1 therebetween, in accordance with the present invention;

FIG. 5 is another three dimensional view of the forging or casting dies of FIG. 4 with the vehicle steering knuckle with the spindle of FIG. 1 therebetween, in accordance with the present invention;

FIG. 6 is a three dimensional view of a cavity of the female die of FIG. 5 in the direction of the arrow 6 of FIG. 5; and

FIG. 7 is a three dimensional view of the forging or casting dies of FIG. 4 with a billet therebetween, in accordance with the present invention;

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

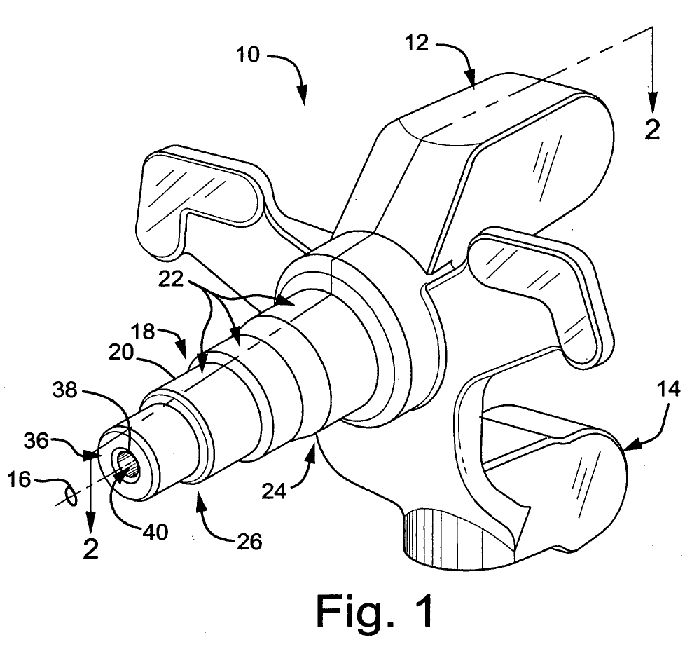

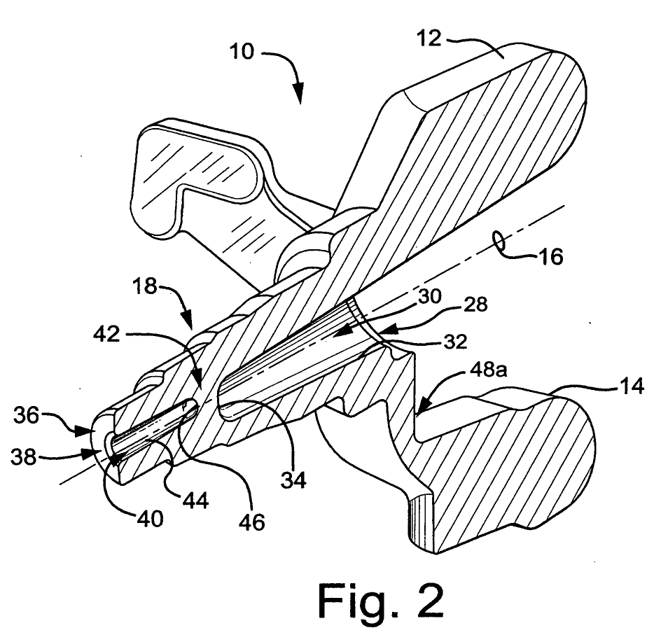

Turning now to FIGS. 1 and 2, one embodiment of a vehicle steering knuckle 10 of the present invention is depicted. The steering knuckle 10 preferably comprises an upper boss portion 12 and a lower boss portion 14. Each boss portion 12,14 is designed to have a king pin channel (not shown) extend entirely therethrough. The king pin channels in the boss portions 12,14 are aligned with one another and generally extend in a perpendicular direction to a longitudinal axis 16 of the steering knuckle 10.

An end portion (not shown) of an axle (not shown) is typically located between the upper and lower boss portions 12, 14. A channel (not shown) is located through the end portion of the axle. This channel is aligned with the king pin channels in the boss portions 12, 14.

A king pin (not shown) is located through king pin channels and the axle channel to pivotally connect the knuckle 10 with the axle. So connected, the knuckle 10 may pivot fore and aft about the end portion of the axle.

The knuckle 10 also comprises a spindle portion 18 that is integrally formed with and unitary with both boss portions 12, 14. The spindle portion 18 extends along the longitudinal axis 16 of the knuckle 10. Preferably, the spindle portion 18 has an outside surface 20 defined by a plurality of segments 22. Each segment has a smaller diameter than the preceding segment from an inboard portion 24 of the spindle portion 18 to an outboard portion 26 of the spindle portion 18.

Those skilled in the art will appreciate that the segments support bearings (not shown). The bearings rotatably support a wheel (not shown) thereon. The wheels may support one or more tires (not shown).

An opening 28 is provided in the spindle portion 18 between the boss portions 12, 14. The opening 28 is connected to a first tapered conical channel 30. The channel 30 extends along the longitudinal axis 16 of the knuckle 10.

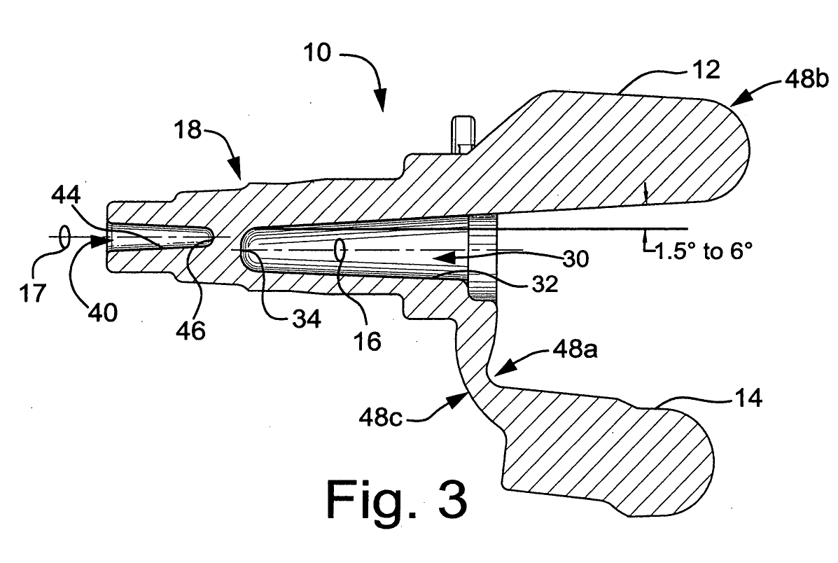

Preferably, the channel 30 has a smooth and gradually tapering interior surface 32. The degree of taper may range from approximately 1.5 degrees to approximately 6 degrees, as shown in FIG. 3.

The channel 30 also has a rounded interior end portion 34. The channel 30, including the interior end portion 34, extends at least half of the length of the spindle portion 18 and may be up to two thirds or three quarters of the spindle portion 18.

The spindle portion 18 has an outermost end portion 36 at the outboard portion 26. An opening 38 is located in the outermost end portion 36. The opening 38 is connected to a second tapered conical channel 40 that extends into the spindle portion 18. The second channel 40 extends toward, but does not connect with, the first tapered conical channel 30. A block 42 of material is left between the first and the second channels 30, 40. However, the spindle portion 18 thereformed possesses a significantly less amount of material than a comparable spindle portion that did not have one or both of the channels 30, 40 formed therein.

In FIG. 2, the second channel 40 is axially aligned with the first channel 30 as indicated by the shared longitudinal axis 16. The present invention is not limited to this embodiment, instead the first and second channels 30, 40 may be axially offset from one another as illustrated in FIG. 3 where the longitudinal axes 16, 17 of, respectively, the first and second channels 30, 40 are illustrated as being offset.

Preferably, the second channel 40 has a smooth and gradually tapering interior surface 44. The degree of taper is as small as possible to minimize the knuckle weight. At the same time, the taper has to be large enough to allow easy extraction of the forging or casting dies 50, 60. The degree of taper usually ranges from approximately 1.5 degrees to approximately 6 degrees as illustrated in FIG. 3 for the first channel 30. The second channel 40 has a rounded interior end portion 46.

In operation, the spindle portion 18 is loaded mostly in bending. This means that any material located along or next to the longitudinal axes 16, 17 is not stressed. Thus, any material along or next to the longitudinal axes 16, 17 does not contribute to the bending strength of the spindle portion 18 and it may be removed. By removing material from an area that does not need the material for strength, then that weight in the knuckle 10 is saved, which lowers the material cost of the knuckle 10.

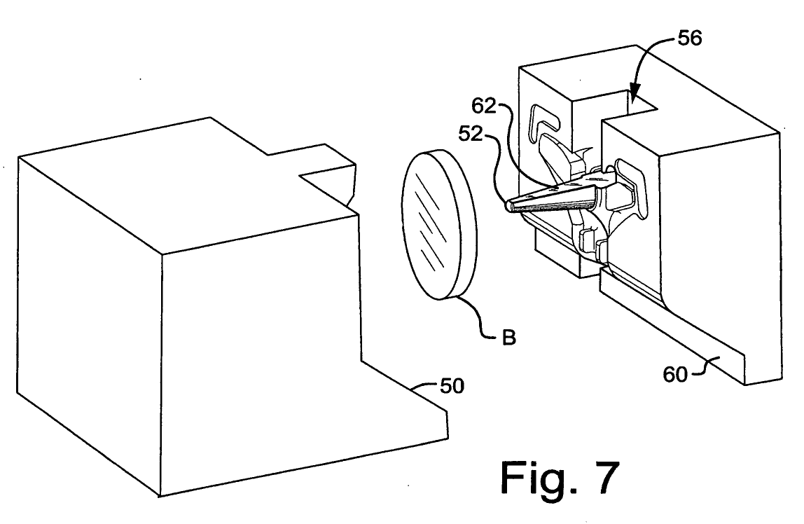

The method of making the forged steering knuckle 10 relies on first providing a female forging die 50 and a male forging die 60 with a metal billet B between the dies 50, 60, as shown in FIG. 7. For a cast metal knuckle the “heat” (not shown but common in the art of casting) would be poured into a die cavity like an opening 56 that is shown in FIG. 7, but where the dies 50, 60 would be closed. For the case of cast knuckles 10, many knuckles 10 may be poured from the same heat of steel. For the case of the metal forged knuckle, the billet B may be of any initial shape, such as square or cylindrical (as shown).

The billet B is heated to a predetermined temperature. The predetermined temperature is a function of the specific material utilized and the amount of the material utilized. Typically, for the billet B, it is a temperature sufficiently high to make the material malleable. For the casting method, the temperature is sufficiently high to make the material flow into a die opening (not shown but common in the art).

The heated material is then urged into a knuckle 10 shape by dies 50, 60. Those skilled in the art will appreciate that a relatively large press (not shown but common in the art) is used to form the initial material into a more complex shape. The general shapes of the spindle portion 18, the boss portions 12, 14 and the first and second tapered conical channels 30, 40 (that is if both are required) are formed.

Utilizing the dies 50, 60 and the press results in smooth transitions between various parts of the knuckle 10. This is advantageous as it minimizes the likelihood that stress fractures will develop in the transition areas. For example, FIGS. 2 and 3 depict transition regions 48a-c between the spindle portion 18 and the lower boss portion 14. The transition regions 48a-c in these areas have gentle and smooth curves.

The dies and press also form uniform wall thicknesses (for example, the areas along the spindle portion 18 in FIG. 3) for a given cross-section in the knuckle 10. This uniform thickness permits uniform cooling of the knuckle 10 which minimizes distortions in the distortions.

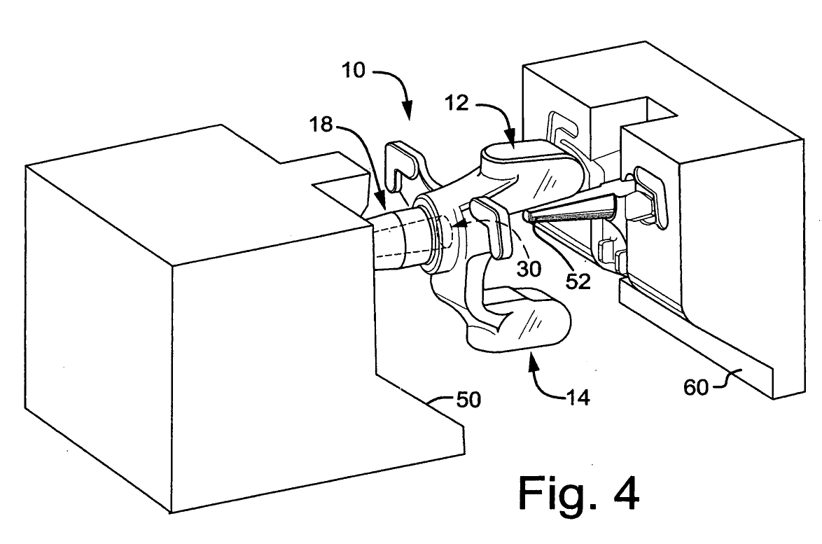

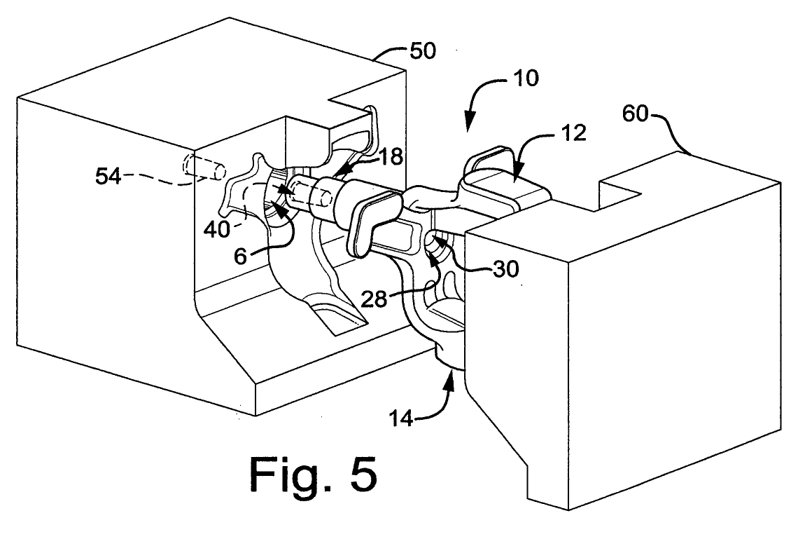

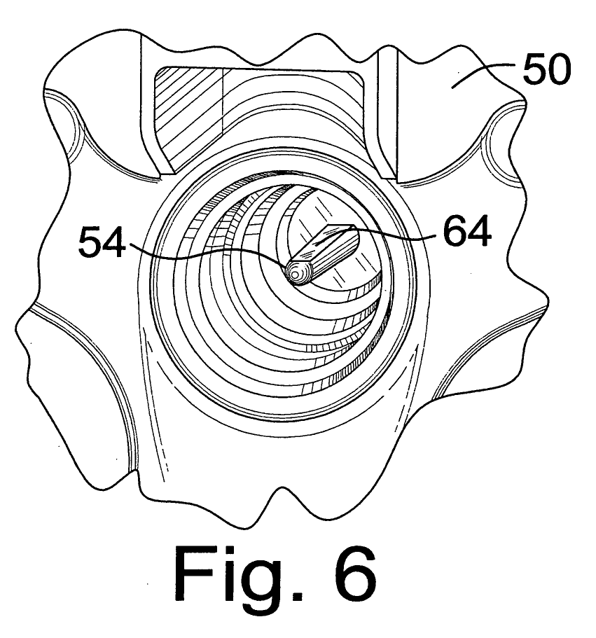

The channels 30, 40 in the knuckle 10 are preferably created by urging conical protrusions 52, 54 on the dies 60, 50 into the knuckle 10. The conical protrusions 52, 54 for the two channels 30, 40 may be moved into the knuckle 10 substantially simultaneously or in two different die steps. FIGS. 4 and 7 show the first tapered conical protrusion 52, which forms the first channel 30, as part of the male die 60. FIGS. 5 and 6 show the second tapered conical protrusion 54, which forms the second channel 30, as part of the female die 50.

The view shown in FIG. 6 is that of a partial view of the female die 50 as seen looking into cavity 6 as illustrated in FIG. 5. Also shown in FIG. 6 is the second tapered conical protrusion 54 with a second tapered conical flat 64, wherein a first tapered conical flat 62 is identified in FIG. 7. These tapered conical flats 62, 64, along with the remaining conical shape of their respective protrusions 52, 54, which are in cooperation with their partial disposal within the spindle portion 18, have been found to result in the easy retrieval of the forging dies or the casting forms 50, 60 following formation (i.e., forging or casting) of the vehicle steering knuckle 10 with spindle 18.

Preferably, each conical protrusion 52, 54 forms the respective conical channel 30, 40 with rounded inner corners 34, 46. The rounded inner corners 34, 46, which act in cooperation with the tapered nature of the channels 30, 40, help to facilitate the easy separation of the conical protrusions 52, 54 from the channels 30, 40. The cavity 6 of FIG. 6 also illustrates the die portions that correspond to the plurality of segments 22 on the outside surface of the spindle portion 18, as illustrated in FIG. 1.

Thus, the degree of taper (i.e., the draft angle), which was mentioned, may physically limit the depth of the conical channel 30, 40 in the core of the spindle portion 18, where the second conical channel 40 allows for less material to be required for the knuckle 10. In addition, the second conical channel 40 may or may not be aligned with the centerline of the first conical channel 30, as illustrated in FIGS. 2 and 3.

As mentioned, the knuckle 10 is created by the dies 50, 60 in a press. Preferably, the dies 50, 60 contact the billet B substantially parallel to the longitudinal axis 16 of the knuckle 10. Contacting the billet B in substantially this direction and manner urges the grains in the material to elongate and to align themselves along the longitudinal axis. With the grains of the material aligned with one another, the knuckle 10 is much stronger than a knuckle whose material grains are not aligned and elongated.

A trimming die (not shown) may be used to form the final version of the forged knuckle 10. The trimming die contacts the knuckle 10 and will remove any flash, or scrap, material that needs to be trimmed. Typically, this is accomplished in a much smaller press, however, this step is not applicable to the casting method.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A forged or cast vehicle knuckle, comprising:
an upper boss portion;
a lower boss portion; and
a spindle portion integrally formed and unitary with both said upper and lower boss portions, wherein an inner opening in said spindle portion is provided between said boss portions, said inner opening connected to a forged or cast tapered conical inner channel extending at least partially through said spindle portion along a longitudinal axis thereof.

2. The forged or cast vehicle knuckle of claim 1, wherein said spindle portion has an outermost end portion opposite said boss portions, said outermost end portion defining an outer opening, said outer opening connected to a forged or cast tapered conical outer channel extending partially toward, but not connected with, said tapered conical inner channel.

3. The forged or cast vehicle knuckle of claim 2, wherein said tapered conical outer channel is axially offset from said tapered conical inner channel.

4. The forged or cast vehicle knuckle of claim 2, wherein said tapered conical inner channel has a taper angle between approximately 1.5 degrees to approximately 6 degrees.

5. The forged or cast vehicle knuckle of claim 1, wherein said spindle portion has an outside surface with a plurality of segments, wherein each segment has a smaller diameter than the preceding segment from an inboard portion to an outboard portion of said spindle portion.

6. The forged or cast vehicle knuckle of claim 1, wherein said inner tapered conical channel is centered within said spindle portion.

7. A method of forging or casting a vehicle steering knuckle, comprising:
providing a metal billet or heat of molten metal;
heating said metal billet or heat to a predetermined temperature;
shaping said heated metal billet or heat in a forging or casting die to have an upper boss, a lower boss and a spindle portion positioned between and unitary with said bosses, thereby forming a forging or casting of a vehicle steering knuckle with a spindle; and
shaping at least one forged or cast tapered conical channel partially extending within said spindle portion with a corresponding tapered conical protrusion on part of said forging or casting die.

8. The method of claim 7, wherein said die contacts said heated metal billet in an axial direction to form said bosses and said spindle portion.

9. The method of claim 7, wherein an inner tapered conical channel is formed in an inboard portion of said spindle and an outer tapered conical channel is formed in an outboard portion of said spindle, said outer tapered conical channel being axially offset from said inner tapered conical channel.

10. The method of claim 7, wherein each of said corresponding tapered conical protrusions forms said forged or cast tapered conical channels with rounded inner corners to permit separation of each of said corresponding tapered conical protrusions from said forging or said casting.

11. The method of claim 7, wherein said each of said corresponding tapered conical protrusions is tapered to permit separation of each of said corresponding tapered said conical protrusions from said forging or said casting.

12. The method of claim 7, wherein material grains within said vehicle steering knuckle with a spindle are aligned along a longitudinal axis of said spindle.
